(19) United States
(12) Patent Application Publication
(10) Pub. No.: US 2020/0081383 A1
(43) Pub. Date: Mar. 12, 2020

(54) DETERMINING MEDIA WEIGHT BASED ON FUSING SYSTEM ENERGY

(71) Applicants: Hewlett-Packard Development Company, L.P., Spring, TX (US); Purdue Research Foundation, West Lafayette, IN (US)

(72) Inventors: Bartley Mark HIRST, Boise, ID (US); Mark SHAW, Boise, ID (US); Jan ALLEBACH, West Lafayette, IN (US); Steven PEKAREK, West Lafayette, IN (US); Xiang ZHANG, West Lafayette, IN (US)

(21) Appl. No.: 16/462,712

(22) PCT Filed: Jan. 25, 2017
(86) PCT No.: PCT/US2017/014920

§ 371 Date: May 21, 2019

(51) Int. Cl. G03G 15/00; G03G 15/20

(52) U.S. Cl. CPC G03G 15/5029; G03G 15/2039

(57) ABSTRACT

In one example in accordance with the present disclosure, a method for determining media weight is described. According to the method, an energy used by a fusing system over a time interval is calculated and a number of pages processed by the fusing system during that time interval is determined. A fusing energy per processed page is then determined based on the energy used by the fusing system and the number of pages processed by the fusing system during the time interval. A media weight is then determined based on the fusing energy per processed page.

### BACKGROUND

Some imaging devices, such as electro-photographic printers form printed marks, such as texts and images, on media by depositing a printing compound, such as toner or ink, onto the media. After application of the printing compound, a fusing system applies heat and pressure to the printing compound and the media.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flowchart of a method for determining media weight based on fusing system energy, according to an example of the principles described herein.

FIG. 2 is a diagram of an imaging system for imaging and determining media weight based on fusing system energy, according to an example of the principles described herein.

FIG. 3 is a flowchart of a method for determining media weight based on fusing system energy, according to another example of the principles described herein.

FIG. 4 is a flowchart of a method for determining media weight based on fusing system energy, according to another example of the principles described herein.

FIG. 5 is a flowchart of a method for determining media weight based on fusing system energy, according to another example of the principles described herein.

FIG. 6 is a diagram of a computing system to determine media weight based on fusing system energy, according to an example of the principles described herein.

Throughout the drawings, identical reference numbers designate similar, but not necessarily identical, elements.

### DETAILED DESCRIPTION

Some imaging devices, such as electro-photographic printers form printed marks, such as texts and images, on media by depositing a printing compound, such as toner or ink, onto the media. After application, a fusing system applies heat and pressure to the printing compound and the media.

The fusing system in such imaging devices can include a pair of rollers, specifically a fuser roller and a pressure roller. The fuser roller is directly heated, for example by an internal heater. The fusing system can be used in dry electro-photographic print/copy systems and wet photographic print/copy systems.

In a dry electro-photographic process, dry toner is applied to a media surface. The toner is in the form of a thermoplastic, which may be based on styrene, styrene-polyester blends, or polyester. In some examples, the type or blend ratio of the thermoplastic is tailored to the specific operating temperatures of the print/copy system and other criteria. In a dry electro-photographic process, the thermoplastic is deposited on the media. The fuser roller then applies heat to the toner/media combination to facilitate bonding of the toner to the media. The pressure roller is not directly heated, but is indirectly heated from contact with the fuser roller. The pressure roller presses against the fuser roller to form a nip. Pressure at the nip facilitates media-toner bonding as the toner is melted and fused to the media by the pressure exerted on it by the fuser roller and the pressure roller. After passing through the nip, the toner is bonded to the media and the media with toner is passed to a discharge tray or another section of the printer.

In a wet photographic process, which may be referred to as an inkjet process, the fusing system conditions the ink/media after the ink has been applied on the surface of the media. For example, in inkjet processes where a significant amount of water-based ink is applied to the media, the media can become very wet. In such a wet state, the media no longer has sufficient beam strength to withstand the forces and stresses of transitioning through the various rollers and media conveyance mechanisms of the print system. In this weakened state, the media may become damaged or may jam up the conveyance mechanisms. Jamming can lead to costly field service to restore the system to operation.

To condition such a wet photographic process, the fusing system heats up the wet media to above the boiling point of water, for example up to 170 degrees C. This causes the excess moisture to quickly evaporate off the media to enhance the beam strength of the media so that it can then travel through the balance of the paper handling system at high speed reducing the risk of media damage and jamming. While the present specification may refer to specific examples of a dry electro-photographic process or an inkjet process, the methods and systems described herein may be used in either system, i.e., a dry electrophotographic imaging device and/or an inkjet imaging device.

While allowing printing compound to be applied onto media to form printed marks such as text and images, the operation of such imaging devices can benefit from increased functionality and technical innovation. For example, the media that may be fed into an imaging system may have different weights. The weight of a media refers to the weight, in pounds, of 500 sheets of the media. Examples of different media weights include 16 weight, 20 weight, 24 weight, 28 weight, and 32 weight. Different weight media respond differently to an applied pressure and temperature and therefore the parameters of the fusing system should be adjusted based on the particular media weight being processed to ensure optimal quality.

Accordingly, some imaging systems use controllers to specify the media being processed. However, such imaging systems may not be accurate in specifying the type of media being processed. For example, some imaging systems rely on user selection of a media type to be processed. However, such user input can be wrong, as users may not be knowledgeable about the weight of paper. Moreover, as media having a weight is switched out for media having a different weight, a user may not adjust the settings of the imaging system to accommodate the different media weight.

An incorrect specification of the media weight could lead to complications with the imaging process. For example, if the fusing temperature is set too high, for example in the case of media weight 32 being specified when media weight 16 is actually being processed, the media can wrap around the fuser roller resulting in a wrap jam. More specifically, if the lighter weight media is processed in a dry electro-photographic system and has a high toner coverage, the molten toner can adhere to the hot fuser roller. The light media has a lower beam strength to force a physical separation of the media/toner from the fuser, and the media may remain temporarily attached the fuser roller as it rotates, resulting in a wrap jam.

Conversely, if heaver media, for example 32 weight media, is installed when a lighter weight media is specified, then the toner may be insufficiently melted and may not fuse with the media. This could result in toner that is easily removed from the media through mechanical action. Other defects may result as well. One such other defect is referred to as “cold offset” where toner is picked off the media surface by the fuser roller and then, after additional rotations of the fuser roller, may become sufficiently molten to then fuse with the media in an undesired location.

Some efforts have been made to determine a media weight, but resulting systems may implement additional hardware components, thus increasing technical complexity, which technical complexity complicates their use and repair. Moreover, such additional sensors and complex weight detecting systems can be expensive.

Accordingly, the present specification describes methods and systems that address these and other issues. Specifically, the present specification describes determining media weight using sensors within a system, which sensors do not directly sense media weight, but rather sense electrical parameters of the fusing system and calculate media weight from the fusing system electrical parameters. Specifically, a fusing system energy consumption is calculated by measuring at least one of a current value, a voltage value, or a power value over a period of time. A number of pages processed by the fusing system over the period of time is determined. From these two values, i.e., a fusing system energy and a number of pages processed over a period of time, a fusing energy per processed page is determined. From the energy per processed page, a media weight can be determined.

With the media weight identified, an operation of the fusing system can be automatically adjusted to optimize the fusing process to increase the quality of the printed mark. For example, proper fusing relies on three variables, 1) time in the nip where fusing occurs, 2) fusing temperature, and 3) fusing pressure. Accordingly, adjustment of the fusing process can include changing the fusing temperature, changing the transport speed of media being fused, and/or changing the pressure between the fuser roller and the pressure roller.

Specifically, the present specification describes a method for determining a fusing energy per page from which media weight can be determined and on which an adjustment of the fusing operation is based. According to the method, an energy used by the fusing system is calculated over a time interval. A number of pages processed by the fusing system over the time interval is determined. A fusing energy per processed page is then determined based on the energy consumed by the fusing system and the number of pages processed by the fusing system during the time interval. A media weight can then be determined based on the fusing energy per processed page.

The present specification also describes an imaging system that includes an imaging device. The imaging system also includes a fusing system to heat the printing compound and the media. A media weight determining system of the imaging system is also included, which includes a sensor to measure an electrical consumption value of the fusing system over a time interval. An energy calculate engine of the media weight determining system calculates an energy used by the fusing system based on the electrical consumption value. A page count engine determines a number of pages processed by the fusing system during the time interval. A fusing energy engine of the media weight determining system determines a fusing energy per processed page based on the energy consumed by the fusing system and the number of pages processed by the fusing system during the time interval. A media weight engine of the media weight determining system determines a media weight based on the fusing energy per processed page.

The present specification also describes a computer system that includes a processor and a machine-readable storage medium coupled to the processor. An instruction set is stored in the machine-readable storage medium and is to be executed by the processor. The instruction set includes instructions to calculate an energy used by a fusing system over a time interval and to determine a number of pages processed by the fusing system during the time interval. The instruction set also includes instructions to determine a fusing energy per processed page based on the energy consumed by the fusing system and the number of pages processed by the fusing system during the time interval. The instruction set also includes instructions to determine a media weight based on the fusing energy per processed page and to adjust an operation of a fusing system based on the determined media weight.

In one example, using such a media weight determining tool 1) determines media weight at a full operational speed; 2) reduces the cost of media weight determination; 3) facilitates accurate media weight determination across a variety of printer models; 4) determines media weight at a faster rate; 5) minimizes energy consumption by providing fusing parameters tailored to the specific media weight present; 6) reduces the propensity of media wrap jams around the fuser roller; 7) reduces warranty expense resulting from complications arising from incorrect media weight measurements; and 8) ensures proper configuration of imaging systems to accommodate an actual media weight processed, even in light of incorrect user indication. However, it is contemplated that the devices disclosed herein may address other matters and deficiencies in a number of technical areas.

As used in the present specification and in the appended claims, the term “printed mark” refers to a glyph, text, or image that is formed on media by depositing a print fluid such as ink or a pigment particle such as toner in a pattern representative of the mark.

Further, as used in the present specification and in the appended claims, the term “duty ratio” refers to a measurement of the supplied power to a fusing system. The duty ratio is based on the voltage supplied to the fusing system, the resistance of the fusing system, and a predetermined percentage of the possible power used by the fusing system.

Still further, as used in the present specification and in the appended claims, the term “imaging” refers to any operation that forms a printed mark such as an image or text on media. Examples of such operations include printing, and copying. Accordingly, printing devices can include electrophotographic printers, inkjet printers, electrophotographic copiers, inkjet copiers, facsimile machines and the like.

Even further, as used in the present specification and in the appended claims, the term “printing compound” refers to any compound that forms printed marks on media. Examples of printing compounds include toner used in a dry imaging operation and ink used in a wet imaging operation.

Even further, as used in the present specification and in the appended claims, the term “a number of” or similar language is meant to be understood broadly as any positive number including 1 to infinity.

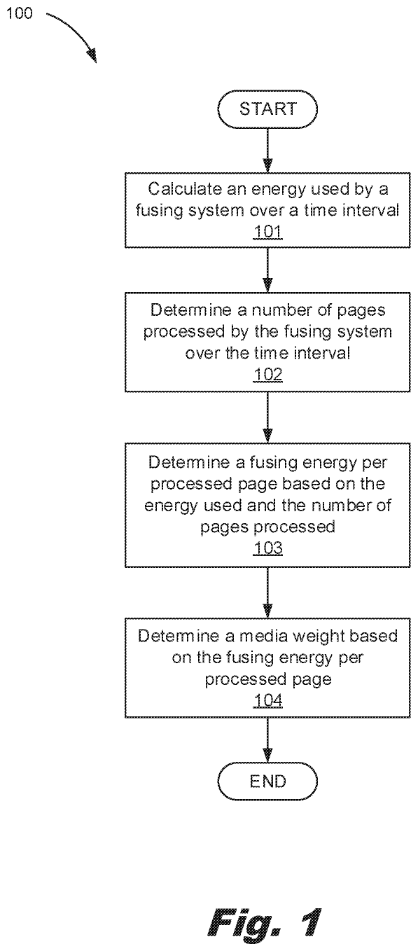

FIG. 1 is a flowchart of a method (100) for determining media weight based on fusing system energy, according to an example of the principles described herein. As a general note, the methods (100, 300, 400, 500) may be described below as being executed or performed by at least one device, for example, a computing device. Other suitable systems and/or computing devices may be used as well. The methods (100, 300, 400, 500) may be implemented in the form of executable instructions stored on at least one machine-readable storage medium of at least one of the devices and executed by at least one processor of at least one of the devices. In one implementation, the machine-readable storage medium may include a standalone program installed on the device. In another implementation, the machine-readable medium may include instructions delivered by a browser on the device. Alternatively or in addition, the methods (100, 300, 400, 500) may be implemented in the form of electronic circuitry (e.g., hardware). While FIGS. 1 and 3-5 depict operations occurring in a particular order, a number of the operations of the methods (100, 300, 400, 500) may be executed concurrently or in a different order than shown in FIGS. 1 and 3-5. In some examples, the methods (100, 300, 400, 500) may include more or fewer operations than are shown in FIGS. 1 and 3-5. In some examples, a number of the operations of the methods (100, 300, 400, 500) may, at certain times, be ongoing and/or may repeat.

According to the method (100), an energy used by a fusing system over a time interval is calculated (block 101). As described above, the fusing system of an imaging system is used to adhere toner to media or evaporate excess moisture away from ink. The energy used value can be used to determine a media weight, which determination is used to adjust fusing operations to ensure proper fusing of toner to media and/or proper evaporation of moisture from ink. The calculation (block 101) can be performed a variety of ways. For example, a power used by the fusing system can be measured. This power used by the fusing system can then be integrated over time to calculate the total energy consumed by the fusing system.

In another example, a current sensor in the fusing system measures a current in the fusing system. In this example, the total energy consumed is based on a measured current consumed by the fusing system, the fusing system resistance, and the duty ratio for the fusing system. In yet another example, total energy consumed can be based on a measured voltage at the fusing system, a fusing system resistance, and a duty ratio of the fusing system.

Calculating (block 101) an energy used by the fusing system may include using a root-mean square value to determine the energy use. For example, a root-mean-square voltage value can be determined, and/or a root-mean-square current value can be determined, and from any of these, an energy use by the fusing system can be calculated (block 101). In determining an energy value, a root-mean-square (RMS) current or voltage is calculated and its value squared. The squared value along with the duty ratio and fuser resistance are used to indicate a power value. The power value is then integrated over time to indicate an energy value. Calculating (block 101) the energy used by the fusing system by using 1) a measurement of either the voltage applied to the fuser or current drawn by the fuser, 2) knowledge of the fuser's heating resistance, and 3) knowledge of the duty ratio of the application of power by the fusing system's temperature control loop leads to an accurate determination of fusing energy. From an accurate indication of energy usage, an accurate media weight determination can be made.

In some examples, calculating (block 101) an energy consumed by the fusing system occurs after a predefined period of time. Prior to the end of the predefined period of time, any energy calculated may not be an accurate indicator of media weight. That is, the fusing system has thermal mass, and a certain amount of energy is absorbed by the fusing system. After the fusing system is brought to a steady state temperature, energy per processed page can accurately determine media weight.

The predefined period of time can be determined by counting a number of pages processed by the fusing system. The predefined period of time may be based on any number of criteria. As one example, the predefined period of time can be defined in part by the environmental conditions of the fusing device at the reception of a job. For example, the relative humidity and/or temperature in a room where the imaging system is located may affect how long it takes the fusing system to arrive at a steady state temperature. Accordingly, any imaging system that includes the fusing system may include sensors that detect ambient temperature, relative humidity, pressure or other environmental conditions. Relying on a lookup table or other database, it can then be determined how many pages should be processed, i.e., what is the predefined period of time, before the energy used by the fusing system should be measured to accurately indicate media weight.

In another example, the predefined period of time is defined by the initial temperature of the fusing system at the reception of a job. Similar to as described above, the initial temperature of the fuser roller in the fusing system will impact how long it takes the pressure roller to arrive at a steady state temperature. As a specific example, if the fusing system is close to operating temperature when a job is started, it may be possible to determine media weight within 8 pages as the fusing system achieves a stable operating temperature relatively quickly. By comparison, if the fusing system has been asleep for a long period of time, an accurate determination of media weight may be made after processing approximately 15 pages at full speed.

As yet another example, the predefined period of time is defined by the operating speed of the fusing system. For example, if the fusing system is operating at a slower speed, the predefined period of time, i.e., the number of pages to be processed before using energy consumed to estimate media weight, might be smaller, for example 4-5 pages. However, when the fusing system is operating at a higher speed, the measurement interval might be larger, for example 8-10 pages.

A number of pages processed by the fusing system during the time interval is also determined (block 102). Information regarding the number of pages processed allows for a determination of fusing energy per page. It is this per page value that can lead to an accurate determination of media weight.

From this information, a fusing energy per processed page can be determined (block 103). That is, the fusing energy per processed page is determined (block 103) based on the energy used by the fusing system and the number of pages processed by the fusing system during the time interval. The fusing energy per processed page refers to the power consumed by the fusing system during the fusing of toner to a particular page or evaporation of excess moisture found in ink on a page.

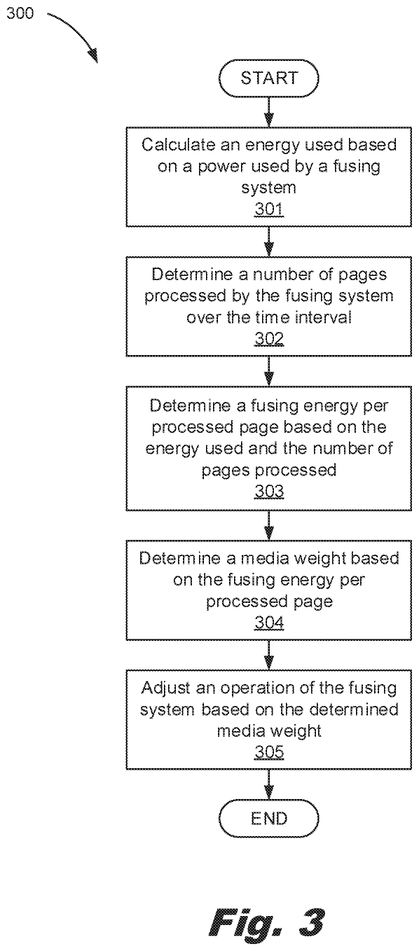

In some examples, the fusing energy per processed page can be based on environmental conditions, such as an initial fusing system temperature and relative humidity. The reliance on environmental conditions when determining fusing energy per processed page may increase the accuracy of media weight determination. That is, the fusing energy used per processed page may vary due to different environmental conditions such as relative humidity or an initial fusing system thermal state. Examples of determining fusing energy per processed page are provided below in connection with FIGS. 3-5.

As described above, there is a strong correlation between the amount of energy used by the fusing system and the weight of the media being processed. Accordingly, once a fusing energy per processed page is determined, a media weight can be determined (block 104) based on the fusing energy per processed page.

In determining (block 104) the media weight from a fusing energy per processed page, a fusing system may rely on a memory storage device. More specifically, a memory storage device may reside on an imaging system, or a consumable used by the imaging system in which a fusing system resides. This memory storage device may include a lookup table, or multiple lookup tables that are indexed based on the initial fusing system conditions, such as an initial temperature. These lookup tables correlate fusing energy per page to a media weight.

Accordingly, with a determination of fusing energy per processed page, the lookup table could be consulted and, considering the initial fusing system temperature, a proper media weight selected.

In some examples, the above-described method (100) is carried out as an associated imaging device is operating at full speed, such that the imaging device does not have to slow down in order to determine media weight. Performing the method (100) while operating at full speed facilitates a non-intrusive production of a printed product.

The above-described method (100) provides for efficient and effective media weight determination. That is, the method (100) above does not rely on any specific media weight sensors, which sensors can be expensive, and technically complex to implement. Rather, the method (100) above relies on input power, current, and/or voltage sensors, which allow for a very accurate determination of input power to be determined, which accuracy leads to more accurate fusing energy per processed page measurements, and still further more accurate media weight determinations.

Moreover, the accurate media weight determination described above allows for optimization of the fusing system. That is, proper fusing for media having a particular weight may be carried out at lowest energy use. Some systems use a high fusing energy, regardless of the media weight, in order to ensure proper fusing. Doing so may lead to the use of a higher fusing temperature than necessary, which increases production costs, reduces efficiency as more power than is needed is drawn, and potentially reduces the life of the fuser roller by exposing it to a greater thermal load than necessary.

Still further, the above method (100) improves technical performance. For example, in a dry electro-photographic imaging device, using a fusing temperature that is too low can degrade the quality of a job as toner is not properly fused to the media and as a result, the toner may wipe off. By comparison, if the fusing temperature is too hot, the toner can become very molten, such that it sticks to the fuser roller and leads to wrap jams where the media wraps around the fuser roller. Other examples of complications that can arise include toner not attaching to media, toner partially attached to the fuser roller and partially attached to the media. Each of these issues can lead to toner being disposed somewhere else on the media. All these technical complications lead to a less effective and less productive toner fusing system. In an inkjet imaging device, temperatures that are too low may not sufficiently evaporate excess fluid such that a target beam strength is not achieved and too much temperature may otherwise adversely impact product quality. Accordingly, by providing for a quick, and accurate determination of media weight, notwithstanding user error, proper operation of the fusing system is ensured, thus ensuring the quality of the print device.

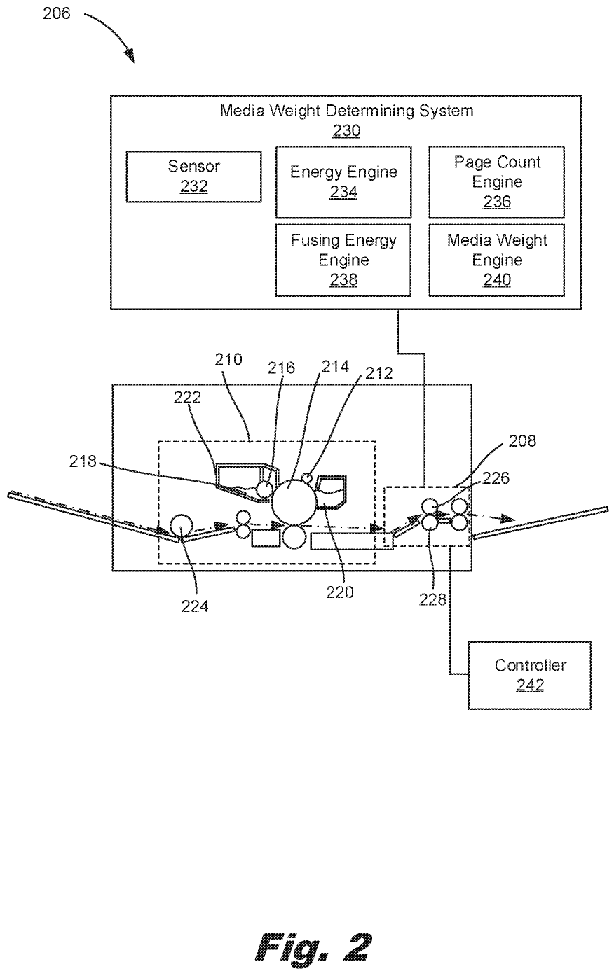

FIG. 2 is a diagram of an imaging system (206) for imaging and determining media weight based on fusing system (208) energy, according to an example of the principles described herein. In some examples, the imaging system (206) includes an imaging device (210) to form printed marks on media. The imaging device (210) may be an inkjet device that deposits fluid ink onto a media surface. In another example, the imaging device (210) is a dry electro-photographic imaging device that deposits toner on a media surface. While specific reference is made to a dry electro-photographic imaging device (210), the principles described herein apply as well to an inkjet imaging device.

In some examples, the imaging device (210) includes a charge roller (212) that is used to charge the surface of a photoconductor drum (214). A laser diode (not shown) is provided that emits a laser beam, which is pulsed on and off as it is swept across the surface of the photoconductor drum (214) to selectively discharge the surface of the photoconductor drum (214). In the orientation shown in FIG. 2, the photoconductor drum (214) rotates in the counterclockwise direction. A developing roller (216) is used to develop a latent electrostatic image on the surface of the photoconductor drum (214) after the surface voltage of the photoconductor drum (214) has been selectively discharged. Toner (218) is stored in a toner reservoir (222) of an electrophotographic print cartridge. The developing roller (216) includes an internal magnet that magnetically attracts the toner (218) from the print cartridge to the surface of the developing roller (216). As the developing roller (216) rotates (clockwise in FIG. 2), the toner (218) is attracted to the surface of the developing roller (216) and is then transferred across the gap between the surface of the photoconductor drum (214) and the surface of the developing roller (216) to develop the latent electrostatic image.

Media, for instance sheets of paper, are loaded from an input tray by a pickup roller (224) into a conveyance path indicated by the dash-dot line in FIG. 2. The media is drawn through the imaging device (210) by drive rollers such that the leading edge of each media is synchronized with the rotation of the region on the surface of the photoconductor drum (214) that includes the latent electrostatic image. As the photoconductor drum (214) rotates, the toner (218) adhered to the discharged areas of the photoconductor drum (214) contact the media, which has been charged by a transfer roller such that the medium attracts the toner particles away from the surface of the photoconductor drum (214) and onto the surface of the media. As some toner may remain on the surface of the photoconductor drum (214), a cleaning blade removes the adhered particles, which are deposited in a toner waste hopper (220).

As the media continues along the conveyance path, the media is delivered to a fusing system (208). The media passes between a fuser roller (226) and a pressure roller (228). As described above, the fuser roller (226) is heated such that at the nip between the fuser roller (226) and the pressure roller (228) exposes the media to high heat and pressure which fuses the toner to the surface of the media. When the imaging device is an inkjet imaging device, the heat and pressure cause excess moisture from the fluid ink to evaporate, thus restoring the beam strength to the media.

In some examples, the fuser roller (226) and pressure roller (228) are formed as hollow tubes constructed out of a material such as aluminum or steel. Each roller (226, 228) generally has an outer layer that is formed of an elastomeric material such as silicon rubber or a flexible thermoplastic. This flexible outer layer allows the fuser roller (226) and pressure roller (228) to compress together to increase the width of the nip, which increases the time that the media resides at the nip. When the print compound is toner, the longer the dwell time in the nip, the larger the total energy that the toner and recording medium can absorb to melt the toner. Within the nip, the toner is melted and fused to the media by the pressure exerted on it by the fuser roller (226) and the pressure roller (228). After the toner has been bonded to the surface of the media, the media is forwarded by a discharge roller to a discharge tray.

As described above, the fuser roller (226) may be heated, which can be accomplished via a high-power tungsten filament quartz lamp inside the hollow fuser roller (226). The heat generated diffuses to the outer surface of the fuser roller (226) until it reaches a temperature sufficient to melt the toner or evaporate the excess moisture from the ink.

The imaging system (206) also includes a media weight determining system (230) to determine the weight of processed media. To achieve its desired functionality, the media weight determining system (230) includes various hardware components. Specifically, the media weight determining system (230) includes a number of engines and sensors. The engines refer to a combination of hardware and program instructions to perform a designated function. The engines may be hardware. For example, the engines may be implemented in the form of electronic circuitry (e.g., hardware). Each of the engines may include its own processor, but one processor may be used by all the modules. For example, each of the engines may include a processor and memory. Alternatively, one processor may execute the designated function of each of the modules. Further, the engines may be distributed across hardware and machine-readable storage mediums of a variety of devices.

The media weight determining system (230) includes a sensor (232) to sense an electrical value of the fusing system (208). For example, the sensor (232) could be a power meter, a voltage sensor or a current sensor. As an example, a current sensor may include a sense resistor or special current or sense transformer. In another example, the voltage sensor may include a voltage divider that measures an instantaneous voltage at the fusing system (208).

An energy engine (234) of the media weight determining system (230) calculates an energy used by the fusing system (208) based on the output from the sensors (232) over a period of time. For example, as will be described below in FIGS. 3-5, if the output is one of a power output, a voltage output, or a current output, the energy engine (234) can use these outputs to determine an energy consumed by the fusing system (208). In some examples, the energy engine (234) is a root-mean-square energy engine (234) that determines a root-mean-square output based on the measured information and determines an energy from the root-mean-square output. More particularly, the energy engine (234) can receive an output voltage or output current, and calculate a RMS voltage or RMS current, and from these values (along with duty ratio and fuser resistance) calculate an energy used by the fusing system (208). The media weight determining system (230) includes a page count engine (236) to determine the number of pages processed during a time interval.

The fusing energy engine (238) of the media weight determining system (230) determines a fusing energy per processed page based on the calculated energy used from the energy engine (234) and the number of pages processed by the fusing system (210) as determined by the page count engine (236). Specifically, with these numbers available, the fusing energy engine (238) determines an amount of power used to heat the printing compound/media, i.e., to fuse toner to an individual page of media or to evaporate a certain amount of moisture away form a page, as calculated over a time interval.

The media weight engine (240) then determines a media weight based on the fusing energy per processed page. In some cases, doing so by consulting a lookup table stored in a database. The database may include a number of lookup tables, each defined by a set of environmental and/or initial conditions. For example, one lookup table may correspond to a first initial temperature at a certain relative humidity and a second lookup table may correspond to a second initial temperature at a different or same relative humidity. The media weight engine (240) may output a media weight value that overrides any user input media weight. For example, as described above, a user may incorrectly specify a media weight, or may fail to account for a change in media used, which could lead to the above-mentioned complications. Accordingly, the media weight engine (240) output may override any user input, thus ensuring accuracy in media weight determination.

In some examples, the media weight determining system (230) operates while the imaging device (210) is operating at full speed. That is, a determination as to media weight can be made while the associated job is being processed. In some cases, the determination of media weight may be made after a certain number of pages have been processed, for example 4-5 pages. Doing so ensures that the fuser roller (226) is at a constant temperature. For example, during initialization, the fuser roller (226) acts as a heat sink drawing power that would otherwise be used to heat the printing compound/media. Accordingly, by waiting until a few pages have been processed, it can be assured that the determination of fuser energy is accurate. Doing so allows for high-speed media weight determination and avoids reducing processing speed to effectuate media weight determination. Otherwise, the job would be slowed while a media weight determined, which negatively impacts productivity of the imaging system (206).

In some examples, the imaging system (206) includes a controller (242) to adjust an operation of the fusing system (208) based on the determined media weight. Specifically, the controller (242) can adjust the fusing temperature, the transport speed of the media through the fusing system (208), and/or a pressure exerted by the pressure roller (228) against the fuser roller (226). Such adjustments ensure that proper fusing parameters exist for different fusing scenarios, i.e., fusing different weighted media.

FIG. 3 is a flowchart of a method (300) for determining media weight based on fusing system (FIG. 2, 208) energy, according to another example of the principles described herein. According to the method (300) an energy used by the fusing system (FIG. 2, 208) is calculated (block 301) based on a power used by the fusing system (FIG. 2, 208). In this example, the sensor (FIG. 2, 232) may be a power meter that measures the instantaneous power used by the fusing system (FIG. 2, 208). The power meter may include a voltage sensor and a current sensor. Values output from these sensors for slices of time can be multiplied together and an instantaneous power value determined. The instantaneous power value can then be integrated over a period of time to determine a total energy consumed by the fusing system (FIG. 2, 208) over the time interval.

Next, a number of pages processed by the fusing system (FIG. 2, 208) over the time interval is then determined (block 302). This can be performed as described above in connection with FIG. 1.

A fusing energy per processed page is determined (block 303) based on the energy consumed by the fusing system (FIG. 2, 208). More specifically, the calculated (block 301) energy value can be divided by the number of pages processed to determine a fusing energy per page. A media weight can then be determined (block 304) based on the fusing energy per processed page. This may be performed as described above in connection with FIG. 1.

Then, an operation of a fusing system (FIG. 2, 208) may be adjusted (block 305). Such adjustments may be made to adjust the fusing parameters of the fusing system (FIG. 2, 208) to more accurately, and effectively, heat the printing compound/media. For example, the temperature of the fuser roller (FIG. 2, 226) could be adjusted, the pressure between the fuser roller (FIG. 2, 226) and the pressure roller (FIG. 2, 228) could be adjusted, or the transport speed of the media through the fusing system (FIG. 2, 208) could be adjusted. Adjusting the transport speed effects the amount of time that the media is disposed between the nip formed by the fuser and pressure rollers and therefore exposed to the higher temperature and/or pressure. In addition to adjusting these parameters a color table relied on by the imaging system (FIG. 2, 206) may be adjusted. Such adjustment may change the emphasis of certain colors whose properties shift based on media weight.

Determining energy used based on a sensor (FIG. 2, 232) that measures power used leads to a highly reliable and highly accurate determination of media weight thus increasing the efficiency of media processing.

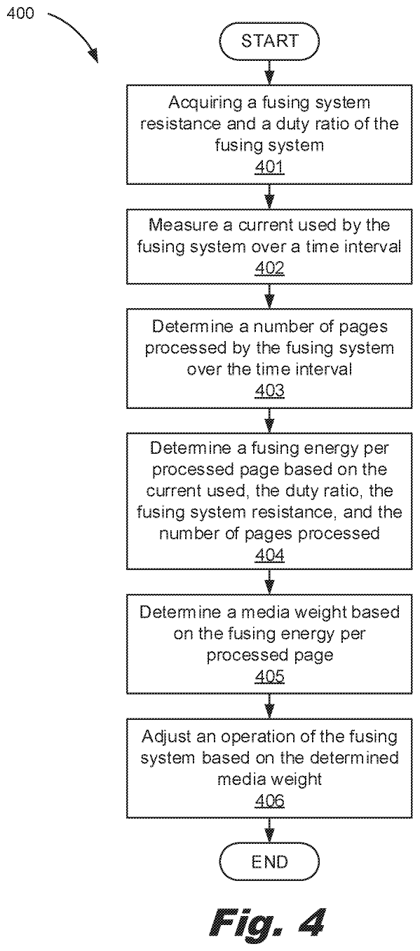

FIG. 4 is a flowchart of a method (400) for determining media weight based on fusing system (FIG. 2, 208) energy, according to another example of the principles described herein. According to the method (400), a fusing system (FIG. 2, 208) resistance and a duty ratio for the fusing system (FIG. 2, 208) can then be acquired (block 401). The fusing system (FIG. 2, 208) resistance refers to the electrical resistance of the fuser's heating element. The fusing system (FIG. 2, 208) resistance and the duty ratio are operating parameters for the fusing system (FIG. 2, 208) and may be affected by the weight of the media being processed. In some examples, these values may be acquired (block 401) by retrieving them from a memory storage and/or measuring them. Specifically, a duty ratio may be measured, and a fusing system resistance acquired from a memory storage device. With regards to stored information, the imaging system (FIG. 2, 206), or a consumable that is used with the imaging system (FIG. 2, 206), may include a memory storage device. The fusing system (FIG. 2, 208) resistance and/or the duty ratio can be stored in these memory storage devices and can be read by the fusing system (FIG. 2, 208).

Next, a current used by the fusing system (FIG. 2, 208) can be measured (block 402). Specifically, a sense resistor or special current/sense transformer can be used to determine the current passing through the fusing system (FIG. 2, 208).

A number of pages processed by the fusing system (FIG. 2, 208) is then determined (block 403) over the time interval. A fusing energy per processed page is then determined (block 404), specifically relying on the current used by the fusing system (FIG. 2, 208), the duty ratio, the fusing system resistance, and the number of pages processed.

Specifically, a processor, such as a processor in a computing system in which the fusing system is disposed, can calculate the fusing energy per page, in joules, using Equation (1) below.

Energy/page=Iᵣₘₛ²×(R_{fuser})×(dutyratio)/(pages)×(time) Equation (1)

In Equation (1) above, Iᵣₘₛ refers to the average root-mean-square current supplied to the fusing system (FIG. 2, 208) over the period of time, R_{fuser} refers to the fusing system (FIG. 2, 208) resistance, duty ratio refers to the average duty ratio of the fuser power controller over the period of time, pages is the page count over the period of time, and time is the elapsed time in seconds over the period of time. From Equation (1), a processor of a computing system determines a fusing energy per processed page. Given that the pages variable and the time variable are values over time, the fusing energy per processed page can be an average fusing energy per processed page over the predetermined period of time.

A media weight can then be determined (block 405) based on the fusing energy per processed page and an operation of the fusing system (FIG. 2, 208) adjusted (block 406) based on the determined media. These may be performed as described above in connection with FIGS. 1 and 3.

Determining energy consumed based on a sensor (FIG. 2, 232) that measures current leads to a strongly reliable and rather accurate determination of media weight at a reduced cost thus increasing the efficiency of media processing.

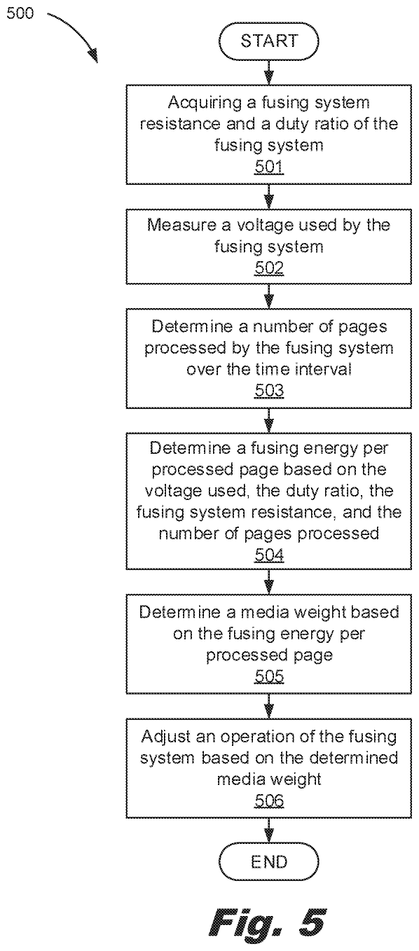

FIG. 5 is a flowchart of a method (500) for determining media weight based on fusing system (FIG. 2, 208) energy, according to another example of the principles described herein. According to the method (500), a fusing system (FIG. 2, 208) resistance and a duty ratio for the fusing system (FIG. 2, 208) can then be acquired (block 501). This may be performed as described in FIG. 4.

Next, a voltage used by the fusing system (FIG. 2, 208) can be measured (block 502). Specifically, the system determines the voltage supplied to the fusing system (FIG. 2, 208).

A number of pages processed by the fusing system (FIG. 2, 208) is then determined (block 503) over the time interval. A fusing energy per processed page is then determined (block 504), specifically relying on the voltage used by the fusing system (FIG. 2, 208), the duty ratio, the fusing system (FIG. 2, 208) resistance, and the number of pages processed.

Specifically, a processor, such as a processor in a computing system in which the fusing system is disposed, can calculate the fusing energy per page, in joules, using Equation (2) below.

$$Energy / page = \frac{{V}_{rms}^{2}}{{R}_{fuser}} ( dutyratio ) / ( pages ) \times ( time ) \qquad Equation ( 2 )$$

In Equation (2) above, Vᵣₘₛ refers to the average root-mean-square voltage supplied to the fusing system (FIG. 2, 208) over the period of time, R_{fuser} refers to the fusing system resistance, duty ratio refers to the average duty ratio of the fuser power controller over the period of time, pages is the page count over the period of time, and time is the elapsed time in seconds over the period of time.

From Equation (2), a processor of a computing system determines a fusing energy per processed page. Given that the pages variable and the time variable are values over time, the fusing energy per processed page can be an average fusing energy per processed page over the predetermined period of time.

A media weight can then be determined (block 505) based on the fusing energy per processed page and an operation of the fusing system adjusted (block 506) based on the determined media. These may be performed as described above in connection with FIGS. 3 and 4.

Determining energy consumed based on a sensor (FIG. 2, 232) that measures RMS voltage leads to a reliable and accurate determination of media weight at an even further reduced cost thus increasing the efficiency of media processing.

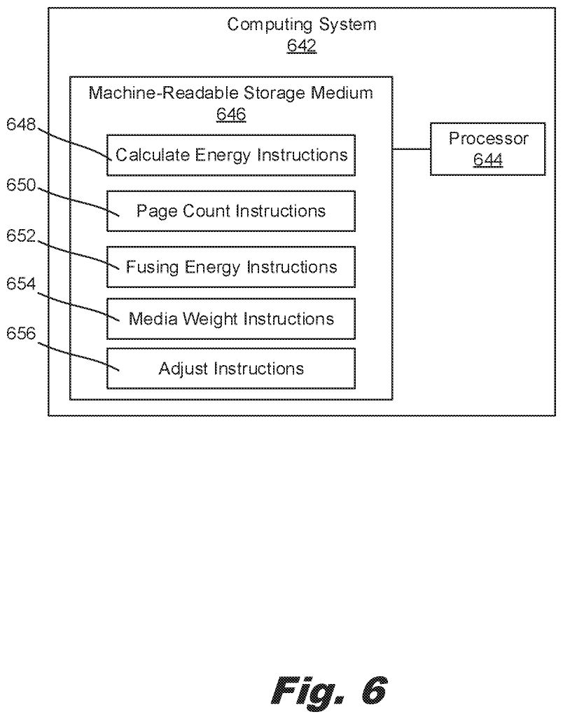

FIG. 6 is a diagram of a computing system (642) to determine media weight based on fusing system (FIG. 2, 208) energy, according to an example of the principles described herein. To achieve its desired functionality, the computing system (642) includes various hardware components. Specifically, the computing system (642) includes a processor (644) and a machine-readable storage medium (646). The machine-readable storage medium (646) is communicatively coupled to the processor (644). The machine-readable storage medium (646) includes a number of instruction sets (648, 650, 652, 654, 656) for performing a designated function. The machine-readable storage medium (646) causes the processor (644) to execute the designated function of the instruction sets (648, 650, 652, 654, 656).

Although the following descriptions refer to a single processor (644) and a single machine-readable storage medium (646), the descriptions may also apply to a computing system (642) with multiple processors and multiple machine-readable storage mediums. In such examples, the instruction sets (648, 650, 652, 654, 656) may be distributed (e.g., stored) across multiple machine-readable storage mediums and the instructions may be distributed (e.g., executed by) across multiple processors.

The processor (644) may include at least one processor and other resources used to process programmed instructions. For example, the processor (644) may be a number of central processing units (CPUs), microprocessors, and/or other hardware devices suitable for retrieval and execution of instructions stored in machine-readable storage medium (646). In the computing system (642) depicted in FIG. 6, the processor (644) may fetch, decode, and execute instructions (648, 650, 652, 654, 656) for controlling a media weight determining system (FIG. 2, 230). In one example, the processor (644) may include a number of electronic circuits comprising a number of electronic components for performing the functionality of a number of the instructions in the machine-readable storage medium (646). With respect to the executable instruction, representations (e.g., boxes) described and shown herein, it should be understood that part or all of the executable instructions and/or electronic circuits included within one box may, in alternate examples, be included in a different box shown in the figures or in a different box not shown.

The machine-readable storage medium (646) represent generally any memory capable of storing data such as programmed instructions or data structures used by the computing system (642). The machine-readable storage medium (646) includes a machine-readable storage medium that contains machine-readable program code to cause tasks to be executed by the processor (644). The machine-readable storage medium (646) may be tangible and/or non-transitory storage medium. The machine-readable storage medium (646) may be any appropriate storage medium that is not a transmission storage medium. For example, the machine-readable storage medium (646) may be any electronic, magnetic, optical, or other physical storage device that stores executable instructions. Thus, machine-readable storage medium (646) may be, for example, Random Access Memory (RAM), a storage drive, an optical disc, and the like. The machine-readable storage medium (646) may be disposed within the computing system (642), as shown in FIG. 6. In this situation, the executable instructions may be “installed” on the computing system (642). In one example, the machine-readable storage medium (646) may be a portable, external or remote storage medium, for example, that allows the computing system (642) to download the instructions from the portable/external/remote storage medium. In this situation, the executable instructions may be part of an “installation package”. As described herein, the machine-readable storage medium (646) may be encoded with executable instructions for determining media weight.

Referring to FIG. 6, calculate energy instructions (648), when executed by a processor (644), may cause the computing system (642) to calculate an energy used by a fusing system (FIG. 2, 208) over a time period. Calculating an energy used by a fusing system (FIG. 2, 208) may be based on an output from a power meter, a current sensor, and/or a voltage sensor.

Page count instructions (650), when executed by a processor (644), may cause the computing system (642) to determine a number of pages processed by the fusing system (FIG. 2, 208) during the time interval. Fusing energy instructions (652), when executed by a processor (644), may cause the computing system (642) to determine a fusing energy per processed page based on the energy consumed by the fusing system (FIG. 2, 208) and the number of pages processed by the fusing system (FIG. 2, 208) during the time interval. Media weight instructions (654), when executed by a processor (644), may cause the computing system (642) to determine a media weight based on the fusing energy per processed page. Adjust instructions (656), when executed by a processor (644), may cause the computing system (642) to adjust an operation of a fusing system based on the determined media weight.

In some examples, calculating energy, determining a fusing energy per processed page, determining a media weight, and adjusting an operation of the fusing system may occur during a job. That is such media weight determining operations can be carried out simultaneously as image processing such that image processing is not impacted by any media weight determining operations. In this example, these operations can be performed after a predetermined number of sheets of the print job have been processed. This is to ensure that the fusing system (FIG. 2, 208) is at a steady state temperature prior to determining media weight. Otherwise, unstable fusing system (FIG. 2, 208) parameters could lead to inaccurate determination of fusing energy per page and consequently, an incorrect media weight determination.

In some examples, the processor (644) and machine-readable storage medium (646) are located within the same physical component, such as a server, or a network component. The machine-readable storage medium (646) may be part of the physical component's main memory, caches, registers, non-volatile memory, or elsewhere in the physical component's memory hierarchy. In one example, the machine-readable storage medium (646) may be in communication with the processor (644) over a network. Thus, the computing system (642) may be implemented on a user device, on a server, on a collection of servers, or combinations thereof.

The computing system (642) of FIG. 6 may be part of a general-purpose computer. However, in some examples, the computing system (642) is part of an application specific integrated circuit.

In one example, using such a media weight determining tool 1) determines media weight at a full operational speed; 2) reduces the cost of media weight determination; 3) facilitates accurate media weight determination across a variety of printer models; 4) determines media weight at a faster rate; 5) minimizes energy consumption by providing fusing parameters tailored to the specific media weight present; 6) reduces the propensity of media wrap jams around the fuser roller; 7) reduces warranty expense resulting from complications arising from incorrect media weight measurements; and 8) ensures proper configuration of imaging systems to accommodate an actual media weight processed, even in light of incorrect user indication. However, it is contemplated that the devices disclosed herein may address other matters and deficiencies in a number of technical areas.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (644) of the computing system (642) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for determining a media weight comprising:
calculating an energy used by a fusing system over a time interval;
determining a number of pages processed by the fusing system during the time interval;
determining a fusing energy per processed page based on the energy used by the fusing system and the number of pages processed by the fusing system during the time interval; and
determining a media weight based on the fusing energy per processed page.

2. The method of claim 1, wherein measuring an energy used comprises measuring, using a power meter, the power used by the fusing system over the time interval.

3. The method of claim 1, wherein:
measuring an energy used comprises:
acquiring a fusing system resistance and a duty ratio of the fusing system; and
measuring a current used by the fusing system; and
determining a fusing energy per processed page is further based on the fusing system resistance, the duty ratio of the fusing system, and the current used by the fusing system.

4. The method of claim 3, further comprising determining a root-mean square current based on the measured current.

5. The method of claim 1, wherein:
measuring an energy consumed comprises:
acquiring a fusing system resistance and a duty ratio of the fusing system; and
measuring a voltage used by the fusing system; and
determining a fusing energy per processed page is further based on the fusing system resistance, the duty ratio of the fusing system, and the voltage used by the fusing system.

6. The method of claim 5, further comprising determining a root-mean square current based on the measured current.

7. The method of claim 1, further comprising adjusting an operation of a fusing system based on a determined media weight.

8. An imaging system comprising:
an imaging device to form printed marks on media by depositing printing compound on the media;
a fusing system to apply heat and pressure to the printing compound and the media; and
a media weight determining system comprising:
a sensor to measure an energy consumption value for the fusing system over a time interval;
an energy engine to calculate an energy used by the fusing system based on the energy consumption value;
a page count engine to determine a number of pages processed by the fusing system during the time interval;
a fusing energy engine to determine a fusing energy per processed page based on the energy used by the fusing system and the number of pages processed by the fusing system during the time interval; and
a media weight engine to determine a media weight based on the fusing energy per processed page.

9. The imaging system of claim 8, wherein the media weight determining system operates while the imaging device is operating at full speed.

10. The imaging system of claim 8, wherein the media weight determining system is activated after a predetermined number of sheets of a job have been processed.

11. The imaging system of claim 8, further comprising a controller to adjust an operation of the fusing system based on a determined media weight by adjusting at least one of the attributes selected from the group consisting of:
a fusing temperature;
a transport speed of the media through the fusing system; and
a pressure exerted by a pressure roller against a fusing roller.

12. A computer system comprising:
a processor;
a machine-readable storage medium coupled to the processor; and
an instruction set, the instruction set being stored in the machine-readable storage medium to be executed by the processor, wherein the instruction set comprises:
instructions to calculate an energy used by a fusing system over a time interval;
instructions to determine a number of pages processed by the fusing system during the time interval;
instructions to determine a fusing energy per processed page based on the energy used by the fusing system and the number of pages processed by the fusing system during the time interval;
instructions to determine a media weight based on the fusing energy per processed page; and
instructions to adjust an operation of a fusing system based on the determined media weight.

13. The computer system of claim 12, wherein the instructions to calculate an energy used by a fusing system over a time interval include instructions selected from the group consisting of:
instructions to calculate energy used based on a measured power used by the fusing system;
instructions to calculate energy used based on a measured voltage used by the fusing system, a fusing system resistance, and a duty ratio of the fusing system; and
instructions to calculate energy used based on a measured current used by the fusing system, the fusing system resistance, and the duty ratio of the fusing system.

14. The computer system of claim 13, wherein the instructions to calculate are further based on environmental conditions of a fusing device.

15. The computer system of claim 12, wherein the instructions are to be executed by the processor during the processing of a job.
